(19) United States
(12) Patent Application Publication
(10) Pub. No.: US 2025/0293451 A1
(43) Pub. Date: Sep. 18, 2025

(54) CONNECTOR TERMINAL AND ELECTRICAL CONNECTOR

(71) Applicant: BYD COMPANY LIMITED, Shenzhen (CN)

(72) Inventors: Xia QIN, Shenzhen (CN); Jinyong XU, Shenzhen (CN); Haijian TANG, Shenzhen (CN); Chaonan CHEN, Shenzhen (CN)

(21) Appl. No.: 19/223,248

(22) Filed: May 30, 2025

Related U.S. Application Data
(63) Continuation of application No. PCT/CN2023/125530, filed on Oct. 20, 2023.

(30) Foreign Application Priority Data
Dec. 20, 2022 (CN) 202223416446.1

(51) Int. Cl. H01R 13/432; H01R 43/16

(52) U.S. Cl. CPC H01R 13/432; H01R 43/16

(57) ABSTRACT

A connector terminal, comprising an insertion-mating part, a catch spring and a catch spring reinforcement structure, the catch spring being arranged on the outer surface of the insertion-mating part, the catch spring comprising a fixing section and an abutting section, one end of the abutting section being connected to the fixing section, the other end of the abutting section being a free end, and the fixing section being connected to the insertion-mating part. In the width direction of the connector terminal, at least one side of the fixing section is connected to the catch spring reinforcement structure, and the abutting section is gradually far away from the insertion-mating part in the extending direction from the fixing section to the free end of the abutting section. In addition, further disclosed in the present application is an electrical connector comprising the above connector terminal.

### CROSS-REFERENCE TO RELATED APPLICATIONS

The present application is a continuation application of PCT application No. PCT/CN2023/125530, filed on Oct. 20, 2023, which claims priority to Chinese Patent Application No. 202223416446.1, filed on Dec. 20, 2022 and entitled “CONNECTOR TERMINAL AND ELECTRICAL CONNECTOR”. The entire content of all of the above-referenced applications is incorporated herein by reference.

### FIELD

The present disclosure relates to the technical field of electrical connectors, and more specifically, to a connector terminal and an electrical connector.

### BACKGROUND

Vehicle parts have a reliability requirement. In complex road conditions and extreme situations, a reliable electrical connection between the vehicle parts needs to be ensured, to ensure safety of a vehicle during driving. The vehicle parts are connected to each other through a connector. Therefore, a terminal structure of the connector needs to maintain reliable contact during vibration and in a complex environment, thereby ensuring a stable and reliable electrical connection between a male terminal and a female terminal. The male terminal and the female terminal of the connector are usually fixed in a sheath of the connector through a catch spring. The catch spring abuts against a stop portion of the sheath, to prevent the terminal from moving in an accommodating cavity, thereby ensuring connection between the male terminal and the female terminal, and enhancing the stable and reliable electrical connection of the connector.

### SUMMARY

To resolve a problem such as that strength of a catch spring structure of an existing connector terminal is low and electrical connection stability is affected, the present disclosure provides a connector terminal and an electrical connector.

The technical solutions adopted in the present disclosure to resolve the above technical problem are as follows.

According to an aspect, the present disclosure provides a connector terminal, which includes: an insertion-mating portion; a catch spring, arranged on an outer surface of the insertion-mating portion, the catch spring including: a fixing section; and an abutting section, one end of the abutting section connecting the fixing section, another end of the abutting section being a free end, the fixing section connecting the insertion-mating portion, the abutting section gradually extending away from the insertion-mating portion in a direction from the fixing section to the free end of the abutting section; and a catch spring reinforcement structure, at least one side of the fixing section connecting the catch spring reinforcement structure in a width direction of the connector terminal.

According to another aspect, the present disclosure provides an electrical connector, which includes a housing and the foregoing connector terminal. The housing is provided with an accommodating cavity configured for the connector terminal to be inserted. An inner wall of the accommodating cavity is provided with a stop portion. When the connector terminal is inserted into the accommodating cavity, the abutting section abuts against the stop portion to prevent the connector terminal from moving in the accommodating cavity.

According to the connector terminal provided in the present disclosure, for a structurally weak position of the catch spring, both sides of the fixing section are provided with the catch spring reinforcement structure. When the catch spring is under an external action, the catch spring reinforcement structure effectively supports the fixing section, which improves structural strength of the fixing section of the catch spring. In this way, a problem of a bending failure or a fracture caused by relatively low strength of the fixing section of the catch spring is prevented. In addition, in a complex environment, a problem of a deformation and a failure caused by low-frequency vibration and high-frequency vibration of the catch spring can be prevented, and movement of the connector terminal can be prevented, thereby improving reliability and stability of an electrical connection of the electrical connector.

### BRIEF DESCRIPTION OF THE DRAWINGS

FIG. 1 is a cross-sectional view of a connector terminal according to embodiments of the present disclosure;

FIG. 2 is a schematic structural diagram of a connector terminal according to embodiments of the present disclosure;

FIG. 3 is a side view of a catch spring according to embodiments of the present disclosure;

FIG. 4 is a schematic structural diagram of a catch spring according to embodiments of the present disclosure;

FIG. 5 is a sectional view of a catch spring according to embodiments of the present disclosure; and

FIG. 6 is a schematic structural diagram of an electrical connector according to embodiments of the present disclosure.

### DETAILED DESCRIPTION

The following detailed description describes general principles of the present disclosure, and examples thereof are additionally shown in the drawings. In the drawings, identical references represent identical or functionally similar elements.

To make technical problems to be solved in the present disclosure, technical solutions, and beneficial effects more comprehensible, the present disclosure is described below in further detail with reference to drawings and embodiments. It should be understood that specific embodiments described herein are merely used for explaining the present disclosure but are not intended to limit the present disclosure.

In the description of the present disclosure, it should be understood that the terms “head end” and “tail end” are orientation limitations based on operating conditions of an insertion-mating portion. For example, an end of the insertion-mating portion for inserting another electrical device is a head end of the insertion-mating portion, and an end of the insertion-mating portion for connecting with a wire is a tail end of the insertion-mating portion, which are merely used for facilitating description of the present disclosure and simplifying the description, rather than indicating or implying that the mentioned apparatus or element need to have a particular orientation or need to be constructed and operated in a particular orientation. Therefore, the terms should not be understood as a limitation on the present disclosure.

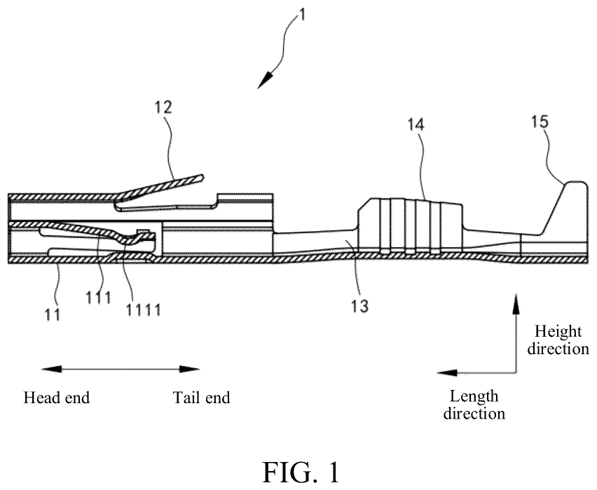

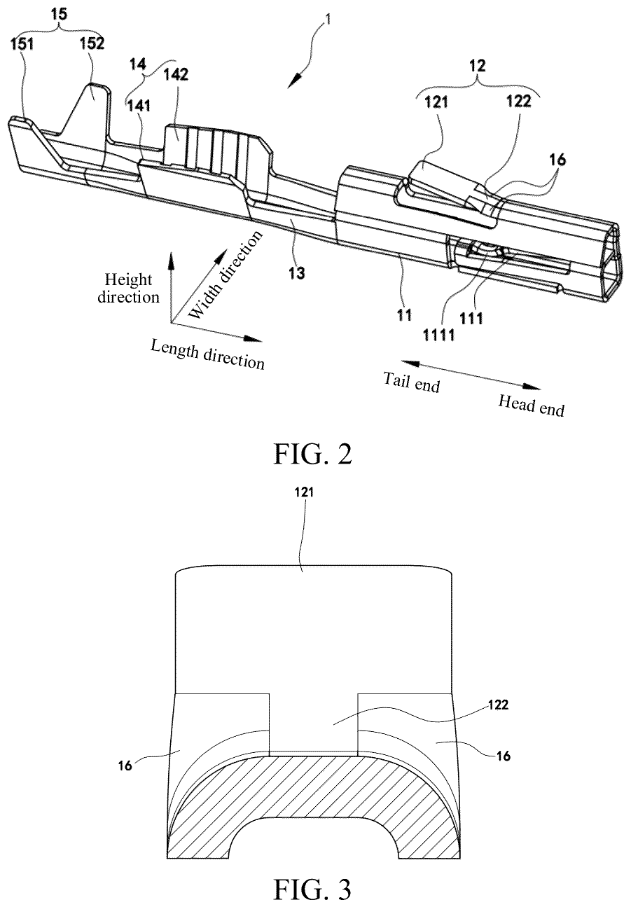

In the description of the present disclosure, a “length direction”, a “width direction”, and a “height direction” of the connector terminal are based on a “length direction”, a “width direction”, and a “height direction” marked in FIG. 1 and FIG. 2.

Referring to FIG. 1 to FIG. 2, an embodiment of the present disclosure provides a connector terminal 1, which includes an insertion-mating portion 11, a catch spring 12, and a catch spring reinforcement structure 16. The catch spring 12 is arranged on an outer surface of the insertion-mating portion 11. The catch spring 12 includes a fixing section 122 and an abutting section 121. One end of the abutting section 121 is connected with the fixing section 122. Another end of the abutting section 121 is a free end. The fixing section 122 is connected with the insertion-mating portion. At least one side of the fixing section 122 is connected with the catch spring reinforcement structure 16 in a width direction of the connector terminal. The abutting section 121 gradually extends away from the insertion-mating portion 11 in a direction from the fixing section 122 to the free end of the abutting section 121.

For a weak position on a structure of the catch spring 12, both sides of the fixing section 122 are provided with the catch spring reinforcement structure 16. When the catch spring 12 is under an external action, the catch spring reinforcement structure 16 effectively supports the fixing section 122, which improves structural strength of the fixing section 122 of the catch spring 12. In this way, a problem of a bending failure or a fracture caused by relatively low strength of the fixing section 122 of the catch spring 12 is prevented. In addition, in a complex environment, a problem of a deformation and a failure caused by low-frequency vibration and high-frequency vibration of the catch spring 12 can be prevented, and movement of the connector terminal 1 can be prevented, thereby improving reliability and stability of an electrical connection of the electrical connector.

In an embodiment, both sides of the fixing section may be connected with the catch spring reinforcement structure in the width direction of the connector terminal.

In an embodiment, the catch spring 12 is arranged on any side wall of the insertion-mating portion 11 other than an end portion.

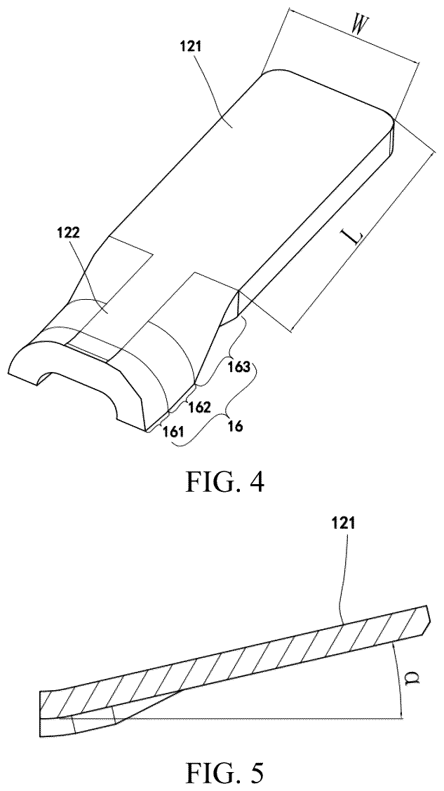

As shown in FIG. 4 and FIG. 5, in an embodiment, an end of the fixing section 122 connected with the insertion-mating portion 11 is a first end. An end of the fixing section 122 connected with the abutting section 121 is a second end. A distance between the fixing section 122 and the insertion-mating portion 11 gradually increases from the first end to the second end in a height direction of the connector terminal 1, to define a slope smoothly transitioning to the abutting section 121.

The fixing section 122 is used as an extension of the abutting section 121, and is configured to connect the abutting section 121 to the insertion-mating portion 11. In addition, during insertion of the connector terminal 1 into an accommodating cavity 21 of a housing 2, the fixing section 122 is elastically deformed, so that the catch spring 12 is close to the outer surface of the insertion-mating portion 11. After the connector terminal 1 is inserted into the accommodating cavity 21 of the housing 2, the elastic deformation of the fixing section 122 is restored and the abutting section 121 is ejected, to limit the connector terminal 1. Moreover, when the connector terminal 1 is under an external force, the abutting section 121 directly conducts the force to the fixing section 122. The fixing section 122 supports the abutting section 121. Therefore, the structural strength of the fixing section 122 is directly related to the structural strength of the catch spring 12.

In an embodiment, relative to a position of the fixing section 122, the catch spring reinforcement structure 16 is at least one of a structure recessed in a direction toward inside of the insertion-mating portion 11 and a structure protruding in a direction facing away from the insertion-mating portion 11.

The structural strength of the fixing section 122 is helped improve by arranging a recessing structure or a protruding structure to cooperate with the fixing section 122.

In some embodiments, the catch spring reinforcement structure 16 includes a connection portion 161, a transition portion 162, and a contraction portion 163 that are sequentially connected. The connection portion 161, the transition portion 162, and the contraction portion 163 are connected to a side surface of the fixing section 122 in the direction from the first end to the second end of the fixing section 122. The connection portion 161 and the transition portion 162 both are an arc-shaped plate structure protruding in the direction facing away from the insertion-mating portion 11.

In an embodiment, one end of the connection portion 161 may be connected with the outer surface of the insertion-mating portion 11. Another end of the connection portion 161 may be connected with an end of the transition portion 162.

In an embodiment, the connection portion 161 and the transition portion 162 both are an arc-shaped plate structure bent in a direction toward the insertion-mating portion 11. One side of the connection portion 161 may be connected with the fixing section 122. Another side of the connection portion 161 may be bent in a direction toward the insertion-mating portion 11. One side of the transition portion 162 may be connected with the fixing section 122. Another side of the transition portion 162 may be bent in a direction toward the insertion-mating portion 11.

In an embodiment, an end of the transition portion 162 connected with the contraction portion 163 is a third end. An end of the transition portion 162 connected with the connection portion 161 is a fourth end. The transition portion 162 is gradually away from the insertion-mating portion 11 from the third end to the fourth end in the height direction of the connector terminal 1. The contraction portion 163 may be connected between the transition portion 162 and the abutting section 121. The contraction portion 163 is in a shape of a plate obliquely extending along the transition portion 162 to the abutting section 121.

The connection portion 161 and the transition portion 162 that are in the arc-shaped plate structure strengthen entire strength of the fixing section 122. The transition portion 162 and the abutting section 121 are smoothly transited through the contraction portion 163. In a structure of the catch spring 12 having an equal length, an equal width, and an equal thickness, the catch spring 12 having the connection portion 161, the transition portion 162, the strength against bending of the catch spring 12 having the catch spring reinforcement structure 16 provided with the connection portion 161, the transition portion 162, and the contraction portion 163 can be greatly improved.

In an embodiment, the insertion-mating portion 11, the catch spring 12, and the catch spring reinforcement structure 16 are integrally formed.

In some embodiments, the insertion-mating portion 11, the catch spring 12, and the catch spring reinforcement structure 16 are obtained by processing a same metal blank. The metal blank may be one or more selected from copper or an alloy thereof, aluminum or an alloy thereof, iron or an alloy thereof, nickel or an alloy thereof, and magnesium or an alloy thereof.

In another embodiment, the insertion-mating portion 11, the catch spring 12, and the catch spring reinforcement structure 16 may alternatively be a split structure.

In an embodiment, the abutting section 121 is an elongated sheet structure. A length of the abutting section 121 ranges from about 1.5 mm to about 3.2 mm. A width of the abutting section 121 ranges from about 0.5 mm to about 1.4 mm.

In some embodiments, the “length of the abutting section 121” is shown by an identifier L in FIG. 4. The “width of the abutting section 121” is shown by an identifier W in FIG. 4.

In an embodiment, an included angle between an extending direction of the abutting section 121 and a length direction of the connector terminal ranges from about 5° to about 60°.

In some embodiments, the “included angle between the abutting section 121 and the outer surface of the insertion-mating portion 11” is shown by an identifier a in FIG. 5. The catch spring 12 is arranged on a top outer surface of the insertion-mating portion 11. The included angle between the abutting section 121 and the outer surface of the insertion-mating portion 11 is an included angle between the abutting section 121 and the top outer surface of the insertion-mating portion 11.

In an embodiment, the insertion-mating portion 11 is a hollow strip-shaped structure.

In an embodiment, the insertion-mating portion 11 is a hollow strip shaped structure with thin-wall formed by winding.

In some embodiments, as shown in FIG. 2, a sheet-shaped metal piece may be bent along a plurality of bending lines to obtain the insertion-mating portion 11. A direction from a head end to a tail end of the insertion-mating portion 11 is used as a preset direction. The bending lines of the insertion-mating portion 11 are parallel to the preset direction. By setting a quantity of the bending lines and a bending angle, insertion-mating portions 11 of different cross-sectional shapes, such as a male terminal shape or a female terminal shape, may be obtained.

As shown in FIG. 1 and FIG. 2, in an embodiment, the insertion-mating portion 11 is a female terminal. In a length direction of the connector terminal 1, the head end of the insertion-mating portion 11 is arranged as an opening, and an elastic contact arm 111 may be arranged in an inner cavity of the insertion-mating portion 11.

The elastic contact arm 111 and the insertion-mating portion 11 are integrally formed. The elastic contact arm 111 is located at an edge position of the blank before the insertion-mating portion 11 is bent and is wound into the inner cavity of the insertion-mating portion 11 by bending. One end of the elastic contact arm 111 may be fixed to an opening position of the insertion-mating portion 11. Another end of the elastic contact arm 111 may be deflected toward the inner cavity of the insertion-mating portion 11, so that the another end of the elastic contact arm 111 is suspended in a middle of the inner cavity of the insertion-mating portion 11, to form an elastic structure. An arc-shaped bent portion 1111 may be formed on the elastic contact arm 111. The male terminal configured to be adapted to the insertion-mating portion 11 is provided with a lug. When the male terminal is inserted into the cavity of the insertion-mating portion 11, the lug may be in elastic contact with the arc-shaped bent portion 1111 of the elastic contact arm 111, thereby implementing an electrical connection.

In another embodiment, the insertion-mating portion 11 may alternatively be the male terminal. A female terminal adapted to the insertion-mating portion 11 is provided with a groove-shaped structure. An electrical connector is arranged in the groove-shaped structure. The insertion-mating portion 11 inserts into the groove-shaped structure and abuts against a corresponding electrical connector to implement an electrical connection.

As shown in FIG. 2, in an embodiment, the connector terminal 1 further includes an extension section 13, a conductive press-fit portion 14, and an insulating press-fit portion 15. One end of the extension section 13 may be connected with a tail end of the insertion-mating portion 11. The insulating press-fit portion 15 may be arranged on another end of the extension section 13. The conductive press-fit portion 14 may be arranged on the extension section 13. The conductive press-fit portion 14 is located between the insulating press-fit portion 15 and the insertion-mating portion 11.

The conductive press-fit portion 14 includes a first press-fit portion 141 and a second press-fit portion 142. The insulating press-fit portion 15 includes a third press-fit portion 151 and a fourth press-fit portion 152. The first press-fit portion 141 and the second press-fit portion 142 are arranged on two sides of a middle portion of the extension section 13 substantially in a V shape. The first press-fit portion 141 and the second press-fit portion 142 are configured to be pressed close to each other to fix a conductive portion of a wire. The third press-fit portion 151 and the fourth press-fit portion 152 are arranged on two sides of a tail end of the extension section 13 substantially in a V shape. The third press-fit portion 151 and the fourth press-fit portion 152 are configured to be pressed close to each other to fix an insulating portion of the wire.

The extension section 13 is a thin-walled strip structure with a substantially U-shaped cross section. The extension section 13 is obtained by extending backward from the tail end of the insertion-mating portion 11. The first press-fit portion 141 and the second press-fit portion 142 are respectively located on two side walls of the extension section 13 and extend to the outside. The third press-fit portion 151 and the fourth press-fit portion 152 are respectively located on two side walls of the tail end of the extension section 13 and extend to the outside. In an extending direction of the extension section 13, the third press-fit portion 151 and the fourth press-fit portion 152 are arranged in a staggered manner.

During use, the connector terminal 1 needs to be electrically connected to a wire. The wire (not shown in the figure) includes a conductive portion with an insulation skin stripped at a front end and an insulating portion with the insulation skin wrapped at a rear end. Part of the conductive portion and the insulating portion are accommodated in a groove of the extension section 13. The conductive portion is located between the first press-fit portion 141 and the second press-fit portion 142. The insulating portion is located between the third press-fit portion 151 and the fourth press-fit portion 152. The first press-fit portion 141 and the second press-fit portion 142 are folded inward toward each other, so as to form functions of clamping and electrical connection for the conductive portion. The third press-fit portion 151 and the fourth press-fit portion 152 are pressed close to each other and surround the outer surface of the insulating portion, so as to form a fixing function on the insulating portion.

In an embodiment, the first press-fit portion 141, the second press-fit portion 142, the third press-fit portion 151, and the fourth press-fit portion 152 each have a sheet-shaped fin structure.

In an embodiment, an angle between the first press-fit portion 141 and the second press-fit portion 142 ranges from about 120° to about 150°, so as to facilitate mounting and fixing of a conductive portion of a wire.

In an embodiment, an angle between the third press-fit portion 151 and the fourth press-fit portion 152 ranges from about 120° to about 150°, so as to facilitate mounting and fixing of an insulating portion of the wire.

In an embodiment, the extension section 13, the first press-fit portion 141, the second press-fit portion 142, the third press-fit portion 151, the fourth press-fit portion 152, and the insertion-mating portion 11 are integrally formed.

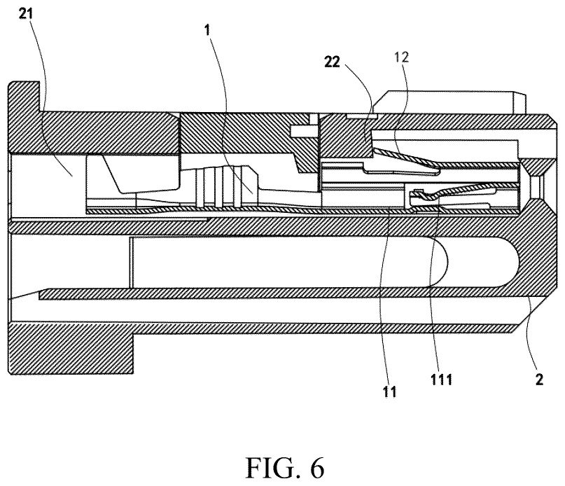

As shown in FIG. 6, another embodiment of the present disclosure provides an electrical connector, which includes a housing 2 and the foregoing connector terminal 1. The housing 2 is provided with an accommodating cavity 21 configured for the connector terminal 1 to be inserted. An inner wall of the accommodating cavity 21 is provided with a stop portion 22. When the connector terminal 1 is inserted into the accommodating cavity 21, the abutting section 121 may abut against the stop portion 22 to prevent the connector terminal 1 from moving in the accommodating cavity 21.

Through the foregoing connector terminal 1, the electrical connector has relatively good electrical performance. The catch spring 12 provides higher position limiting strength, to prevent the deformation and the failure of the catch spring 12 caused by low-frequency vibration or high-frequency vibration of the connector terminal 1, thereby ensuring reliability and stability of an electrical connection of the electrical connector.

In an embodiment, a through hole in communication with the stop portion 22 may be provided on a side wall of the housing 2. When the connector terminal 1 needs to be pulled out from the accommodating cavity 21, the abutting section 121 of the catch spring 12 may be pressed through the through hole, to separate the abutting section 121 of the catch spring 12 from the stop portion 22, thereby relieving the limiting function for the connector terminal 1.

The catch spring reinforcement structure is either a structure recessed towards the inside of the insertion-mating portion or a structure protruding away from the insertion-mating portion. The insertion-mating portion may be a hollow strip shaped structure with thin-wall formed by winding. The extension section may have different cross-sectional shapes by adjusting the bending lines and angles during the manufacturing process. The press-fit portions may have different angles and configurations to accommodate different wire types (including but not limited to Copper Wires, Aluminum Wires, Tinned Copper Wires, Stranded Wires, Solid Wires, etc.) and insulation materials (including but not limited to Polyvinyl Chloride, Polyethylene, Polyvinylidene Fluoride, Cross-Linked Polyethylene, Ethylene Propylene Rubber, Polytetrafluoroethylene, Fluorinated Ethylene Propylene, Silicone Rubber, Thermoplastic Elastomers, Halogen-Free Polycarbonate, etc.). The housing may have a through hole in communication with the stop portion to facilitate the removal of the connector terminal.

The present disclosure has been described in detail with reference to preferred embodiments thereof, but the preferred embodiments are not intended to limit the present disclosure. Any modification, equivalent replacement, or improvement made within the spirit and principle of the present disclosure shall fall within the protection scope of the present disclosure.

What is claimed is:

1. A connector terminal, comprising:
an insertion-mating portion;
a catch spring, arranged on an outer surface of the insertion-mating portion, the catch spring comprising:
a fixing section; and
an abutting section, wherein one end of the abutting section connects with the fixing section, another end of the abutting section is a free end, the fixing section connects the insertion-mating portion, the abutting section gradually extending away from the insertion-mating portion in a direction from the fixing section to the free end of the abutting section; and
a catch spring reinforcement structure, wherein at least one side of the fixing section connects with the catch spring reinforcement structure in a width direction of the connector terminal.

2. The connector terminal according to claim 1, wherein both sides of the fixing section are connected with the catch spring reinforcement structure in the width direction of the connector terminal.

3. The connector terminal according to claim 1, wherein an end of the fixing section connected with the insertion-mating portion is a first end; an end of the fixing section connected with the abutting section is a second end; and a distance between the fixing section and the insertion-mating portion gradually increases from the first end to the second end in a height direction of the connector terminal, to define a slope smoothly transitioning to the abutting section.

4. The connector terminal according to claim 3, wherein the catch spring reinforcement structure is at least one of a structure recessed in a direction toward inside of the insertion-mating portion and a structure protruding in a direction facing away from the insertion-mating portion.

5. The connector terminal according to claim 4, wherein the catch spring reinforcement structure comprises a connection portion, a transition portion, and a contraction portion that are sequentially connected; the connection portion, the transition portion, and the contraction portion are sequentially connected to a side surface of the fixing section in the direction from the first end to the second end of the fixing section; and the connection portion and the transition portion both are an arc-shaped plate structure protruding in the direction facing away from the insertion-mating portion.

6. The connector terminal according to claim 5, wherein one end of the connection portion is connected with the outer surface of the insertion-mating portion; and another end of the connection portion is connected with an end of the transition portion.

7. The connector terminal according to claim 5, wherein the connection portion and the transition portion both are an arc-shaped plate structure bent in a direction toward the insertion-mating portion.

8. The connector terminal according to claim 5, wherein an end of the transition portion connected with the contraction portion is a third end; an end of the transition portion connected with the connection portion is a fourth end; the transition portion is gradually away from the insertion-mating portion from the third end to the fourth end in the height direction of the connector terminal; the contraction portion is connected between the transition portion and the abutting section; and the contraction portion is in a shape of a plate obliquely extending along the transition portion to the abutting section.

9. The connector terminal according to claim 1, wherein the insertion-mating portion, the catch spring, and the catch spring reinforcement structure are integrally formed.

10. The connector terminal according to claim 1, wherein the abutting section is an elongated sheet structure; a length of the abutting section ranges from about 1.5 mm to about 3.2 mm; and a width of the abutting section ranges from about 0.5 mm to about 1.4 mm.

11. The connector terminal according to claim 1, wherein an included angle between an extending direction of the abutting section and a length direction of the connector terminal ranges from about 5° to about 60°.

12. The connector terminal according to claim 1, wherein the insertion-mating portion is a hollow strip-shaped structure.

13. The connector terminal according to claim 1, wherein in a length direction of the connector terminal, a head end of the insertion-mating portion is arranged as an opening, and an elastic contact arm is arranged in an inner cavity of the insertion-mating portion.

14. The connector terminal according to claim 1, further comprising an extension section, a conductive press-fit portion, and an insulating press-fit portion, one end of the extension section connects a tail end of the insertion-mating portion, the insulating press-fit portion being arranged on another end of the extension section, the conductive press-fit portion being arranged on the extension section, and the conductive press-fit portion being located between the insulating press-fit portion and the insertion-mating portion.

15. An electrical connector, comprising a housing, and a connector terminal,
wherein the connector terminal includes:
an insertion-mating portion;
a catch spring, arranged on an outer surface of the insertion-mating portion, the catch spring comprising:
a fixing section; and
an abutting section, one end of the abutting section connecting the fixing section, another end of the abutting section being a free end, the fixing section connecting the insertion-mating portion, the abutting section gradually extending away from the insertion-mating portion in a direction from the fixing section to the free end of the abutting section; and
a catch spring reinforcement structure, at least one side of the fixing section connecting the catch spring reinforcement structure in a width direction of the connector terminal, and
wherein the housing is provided with an accommodating cavity configured for the connector terminal to be inserted, an inner wall of the accommodating cavity is provided with a stop portion, and when the connector terminal is inserted into the accommodating cavity, the abutting section abuts against the stop portion to prevent the connector terminal from moving in the accommodating cavity.

16. The electrical connector according to claim 15, wherein both sides of the fixing section are connected with the catch spring reinforcement structure in the width direction of the connector terminal.

17. The electrical connector according to claim 15, wherein an end of the fixing section connected with the insertion-mating portion is a first end; an end of the fixing section connected with the abutting section is a second end; and a distance between the fixing section and the insertion-mating portion gradually increases from the first end to the second end in a height direction of the connector terminal, to define a slope smoothly transitioning to the abutting section.

18. The electrical connector according to claim 17, wherein the catch spring reinforcement structure is at least one of a structure recessed in a direction toward inside of the insertion-mating portion and a structure protruding in a direction facing away from the insertion-mating portion.

19. The electrical connector according to claim 18, wherein the catch spring reinforcement structure comprises a connection portion, a transition portion, and a contraction portion that are sequentially connected; the connection portion, the transition portion, and the contraction portion are sequentially connected to a side surface of the fixing section in the direction from the first end to the second end of the fixing section; and the connection portion and the transition portion both are an arc-shaped plate structure protruding in the direction facing away from the insertion-mating portion.

20. A method of manufacturing a connector terminal, comprising:
providing a metal blank comprising a conductive material;
stamping and forming the metal blank to create stamped and formed components including an insertion-mating portion, a catch spring, and a catch spring reinforcement structure;
heat treating on the stamped and formed components;
surface treating the connector terminal; and
assembling the connector terminal with a housing, the housing having an accommodating cavity with a stop portion configured to engage with an abutting section of the catch spring to prevent movement of the connector terminal within the accommodating cavity.
